(19) United States
(12) Patent Application Publication
(10) Pub. No.: US 2026/0262010 A1
(43) Pub. Date: Sep. 3, 2026

(54) COMMUNICATION METHOD, COMMUNICATION DEVICE, AND RECORDING MEDIUM

(71) Applicant: Panasonic Intellectual Property Management Co., Ltd., Osaka (JP)

(72) Inventor: Mitsuhiro IMAO, Tokyo (JP)

(21) Appl. No.: 19/654,745

(22) Filed: Apr. 22, 2026

Related U.S. Application Data
(63) Continuation of application No. PCT/JP2024/037010, filed on Oct. 17, 2024.

(30) Foreign Application Priority Data
Oct. 31, 2023 (JP) 2023-187180

(51) Int. Cl. H04W 64/00

(52) U.S. Cl. CPC H04W 64/00

(57) ABSTRACT

A communication method includes: obtaining first position information indicating a position of a first user who is a target recipient of communication; obtaining second position information indicating a position of a second user different from the first user; determining a relative direction of the position indicated in the second position information with respect to the position indicated in the first position information; and communicating using a stimulus presenter capable of presenting a stimulus to the first user, the communicating including presenting a stimulus arriving toward the position indicated in the first position information from the relative direction determined, wherein the stimulus presented in the communicating corresponds to a stimulus generated at the position of the second user.

### DESCRIPTION

### CROSS REFERENCE TO RELATED APPLICATIONS

This is a continuation application of PCT International Application No. PCT/JP2024/037010 filed on October 17, 2024, designating the United States of America, which is based on and claims priority of Japanese Patent Application No. 2023-187180 filed on October 31, 2023. The entire disclosures of the above-identified applications, including the specifications, drawings, and claims are incorporated herein by reference in their entirety.

### FIELD

The present disclosure relates to a communication method, a communication device, and a recording medium.

### BACKGROUND

Conventionally, users receive communication based on information about other users. For example, Patent Literature (PTL) 1 discloses presenting a location-related message that shows a user a position associated with a personal message (in other words, communicating or reproducing location information through messaging).

### Citation List

### Patent Literature

PTL 1: Japanese Unexamined Patent Application Publication No. 2017-107571

### SUMMARY

### Technical Problem

However, presentation such as that disclosed in PTL 1 may not be appropriate. In view of this, the present disclosure has an object to provide a communication method and the like that enable more appropriate communication based on information about a user.

### Solution to Problem

A communication method according to one aspect of the present disclosure includes: obtaining first position information indicating a position of a first user who is a target recipient of communication; obtaining second position information indicating a position of a second user different from the first user; determining a relative direction of the position indicated in the second position information with respect to the position indicated in the first position information; and communicating using a stimulus presenter capable of presenting a stimulus to the first user, the communicating including presenting a stimulus arriving toward the position indicated in the first position information from the relative direction determined, wherein the stimulus presented in the communicating corresponds to a stimulus generated at the position of the second user.

A communication device according to one aspect of the present disclosure includes: a first obtainer that obtains first position information indicating a position of a first user who is a target recipient of communication; a second obtainer that obtains second position information indicating a position of a second user different from the first user; a direction determiner that determines a relative direction of the position indicated in the second position information with respect to the position indicated in the first position information; and an outputter that uses a stimulus presenter capable of presenting a stimulus to the first user to present a stimulus arriving toward the position indicated in the first position information from the relative direction determined, wherein the stimulus presented by the outputter corresponds to a stimulus generated by the second user.

One aspect of the present disclosure may be realized as a non-transitory computer-readable recording medium for use in a computer, the recording medium having a computer program recorded thereon for causing the computer to execute a communication method described above.

Note that these general or specific aspects may be implemented using a system, a device, a method, an integrated circuit, a computer program, or a non-transitory computer-readable recording medium such as a CD-ROM, or any combination thereof.

### Advantageous Effects

The present disclosure enables more appropriate communication based on information about a user.

### BRIEF DESCRIPTION OF DRAWINGS

These and other advantages and features will become apparent from the following description thereof taken in conjunction with the accompanying Drawings, by way of non-limiting examples of embodiments disclosed herein.

FIG. 1 is a diagram for explaining an example of use of a communication system according to an embodiment of the present disclosure.

FIG. 2 is a block diagram illustrating the functional configuration of a communication system according to an embodiment of the present disclosure.

FIG. 3 is a diagram illustrating an example of information stored in storage according to an embodiment of the present disclosure.

FIG. 4 is a flowchart illustrating an operation example of a communication device according to an embodiment of the present disclosure.

### DESCRIPTION OF EMBODIMENT ( S )

### Underlying Knowledge Forming Basis of the Disclosure

Conventionally, users receive communication based on information about other users. For example, with the presentation of location-related messages disclosed in PTL 1, a user may express interest in a set of individuals represented in a set of personal stores (e.g., friends in a social network and colleagues in an academic directory). Such individuals may send location-related messages to personal stores, and a user may request presentation of the location from each personal store. According to PTL 1, messages from personal stores may be collected, and locations associated with the collected messages may be presented on a map. This thereby presents the locations of individuals’ messages to the user regardless of which personal store each message was received from. Furthermore, the map may present messages to the user, and upon receiving a reply to a message from the user, may send that message to the original personal store from which the message was received. Stated differently, PTL 1 discloses presentation of location-related messages that presents locations of individuals’ messages to a user on a map or the like.

However, in such presentation, although the locations of individuals’ messages can be perceived by viewing a presented map or the like, conversely, the locations of individuals’ messages cannot be perceived without viewing the map or the like.

Stated differently, in order to perceive location, an active action of viewing is required, and there is a problem that location is difficult to perceive while performing other tasks, for example. Moreover, presentation of location using a map or the like is an inorganic method; communication based on information about the user through a more organic presentation may be preferred. Organic presentation is, for example, presentation that can reproduce the sense of presence of a living being such as a person or animal, or the warmth of a living being.

In view of this, the present disclosure describes a communication method and the like that, as more appropriate communication based on information about a user, in the presentation of a stimulus for realizing the communication, imparts the concept of direction to the stimulus itself, enables perceptual recognition of position, and performs communication through an organic presentation by such perceptual recognition.

More specifically, a communication method according to a first aspect of the present disclosure includes: obtaining first position information indicating a position of a first user who is a target recipient of communication; obtaining second position information indicating a position of a second user different from the first user; determining a relative direction of the position indicated in the second position information with respect to the position indicated in the first position information; and communicating using a stimulus presenter capable of presenting a stimulus to the first user, the communicating including presenting a stimulus arriving toward the position indicated in the first position information from the relative direction determined, wherein the stimulus presented in the communicating corresponds to a stimulus generated at the position of the second user.

According to such a communication method, since the concept of direction, namely the direction of arrival of the stimulus, is imparted in the communication, the position, that is, the position of the second user, can be passively perceived from the presented stimulus. Furthermore, communication can be performed through an organic presentation that allows the first user to perceptually recognize the position. Furthermore, since the first user merely needs to passively perceive the presented stimulus, the first user can perceive the stimulus while performing another task without interrupting that task. This enables more appropriate communication based on information about the user.

For example, a communication method according to a second aspect of the present disclosure is the communication method according to the first aspect, wherein the stimulus presented in the communicating is at least one of a visual stimulus, an auditory stimulus, a tactile stimulus, or an olfactory stimulus.

This enables more appropriate communication based on information about the user, where the communication is at least one of communication accompanied by presentation of a visual stimulus, communication accompanied by presentation of an auditory stimulus, communication accompanied by presentation of a tactile stimulus, or communication accompanied by presentation of an olfactory stimulus.

For example, a communication method according to a third aspect of the present disclosure is the communication method according to the first or second aspect, further including: obtaining second user information regarding the second user; and determining the stimulus to be presented in the communicating based on the second user information obtained.

With this, the stimulus for communication can be determined based on the second user information.

For example, a communication method according to a fourth aspect of the present disclosure is the communication method according to the third aspect, wherein the stimulus to be presented in the communicating is an auditory stimulus, and in the determining of the stimulus, the auditory stimulus to be presented as the stimulus in the communicating is determined from among a plurality of auditory stimulus candidates based on the second user information.

This enables more appropriate communication accompanied by presentation of an auditory stimulus based on information about the user. The auditory stimulus to be presented can be an auditory stimulus determined from among a plurality of auditory stimulus candidates, based on the second user information.

For example, a communication method according to a fifth aspect of the present disclosure is the communication method according to the third or fourth aspect, wherein the second user information includes at least one of event information, activity information, attribute information, or vital information of the second user.

With this, at least one of event information, activity information, attribute information, or vital information of the second user can be used as the second user information.

For example, a communication method according to a sixth aspect of the present disclosure is the communication method according to the fifth aspect, wherein the event information is obtained based on a schedule registered in advance for the second user.

With this, event information of the second user obtained based on a schedule registered in advance for the second user can be used as the second user information.

For example, a communication method according to a seventh aspect of the present disclosure is the communication method according to the sixth aspect, wherein the communicating is executed in conjunction with the schedule related to the event information.

With this, event information of the second user obtained based on a schedule registered in advance for the second user can be used as the second user information, and the stimulus can be presented and communicated in conjunction with a schedule related to the event information.

For example, a communication method according to an eighth aspect of the present disclosure is the communication method according to any one of the fifth to seventh aspects, wherein the activity information is obtained by sensing the second user, or is obtained based on the event information.

With this, activity information of the second user obtained by sensing the second user, or activity information of the second user obtained based on event information, can be used as the second user information.

For example, a communication method according to a ninth aspect of the present disclosure is the communication method according to any one of the fifth to eighth aspects, wherein the attribute information is obtained based on personal information of the second user.

With this, attribute information obtained based on personal information of the second user can be used as the second user information.

For example, a communication method according to a tenth aspect of the present disclosure is the communication method according to any one of the fifth to ninth aspects, wherein the vital information is obtained by sensing the second user.

With this, vital information obtained by sensing the second user can be used as the second user information.

For example, a communication device according to an eleventh aspect of the present disclosure includes: a first obtainer that obtains first position information indicating a position of a first user who is a target recipient of communication; a second obtainer that obtains second position information indicating a position of a second user different from the first user; a direction determiner that determines a relative direction of the position indicated in the second position information with respect to the position indicated in the first position information; and an outputter that uses a stimulus presenter capable of presenting a stimulus to the first user to present a stimulus arriving toward the position indicated in the first position information from the relative direction determined, wherein the stimulus presented by the outputter corresponds to a stimulus generated by the second user.

With this, the same effects as the communication method described above can be achieved.

For example, a recording medium according to a twelfth aspect of the present disclosure is a non-transitory computer-readable recording medium for use in a computer, the recording medium having a computer program recorded thereon for causing the computer to execute the communication method according to any one of the first to tenth aspects.

With this, by executing the computer program using a computer, the same effects as the communication method described above are achieved.

Furthermore, these general or specific aspects may be implemented using a system, a device, a method, an integrated circuit, a computer program, or a non-transitory computer-readable recording medium such as a CD-ROM, or any combination thereof.

Hereinafter, one or more embodiments of the present disclosure will be described in detail with reference to the drawings. Each embodiment described below presents a general or specific example. The numerical values, shapes, materials, elements, the arrangement and connection of the elements, steps, the processing order of the steps etc., shown in the following one or more embodiments are mere examples, and do not limit the scope of the present disclosure. Accordingly, among the elements in the following one or more embodiments, those not recited in any of the independent claims are described as optional elements. Moreover, the figures are schematic diagrams and are not necessarily precise illustrations. In the figures, elements that are essentially the same share the same reference signs, and repeated description may be omitted or simplified.

In the following description, elements may be assigned with ordinal numbers such as “first”, “second”, and “third”. These ordinal numbers are given to elements in order to distinguish the elements from each other, and thus do not necessarily correspond to an order that has intended meaning. These ordinal numbers may be substituted, newly assigned, or removed as appropriate.

In the present disclosure, communication refers to a process whereby one user encodes a stimulus representing information or a sensation to be communicated into a communication medium, through which another user receives presentation of the stimulus via the communication medium and perceives the information or sensation to be communicated. In the present disclosure, a stimulus does not mean “a stimulus that gives a shock”, but only means “something that acts on a sensory organ”, and there is no particular limitation on the manner or degree of action on the sensory organ.

### Embodiment

### Overview

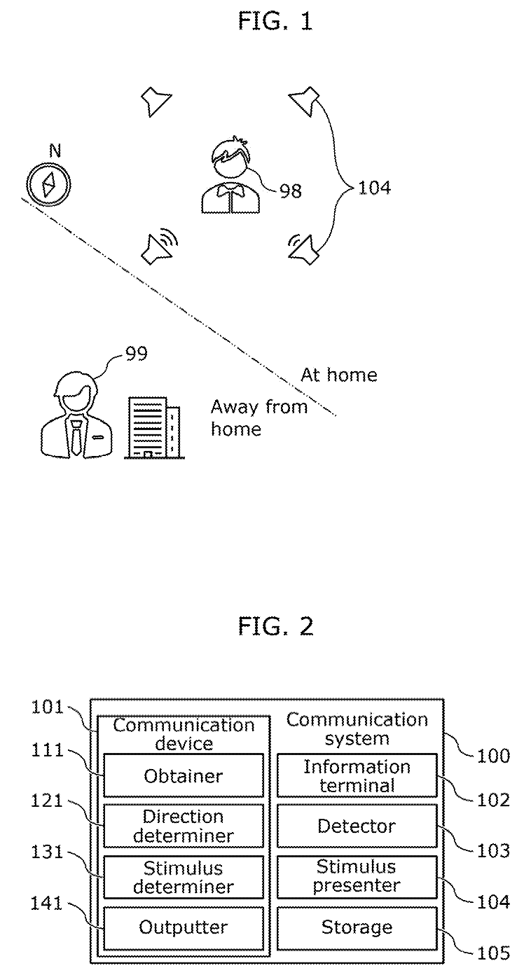

First, an overview of a communication system according to the embodiment will be described. FIG. 1 is a diagram for explaining an example of use of the communication system according to the embodiment. FIG. 1 illustrates first user 98 to whom a stimulus from stimulus presenter 104 is presented by communication system 100 (see FIG. 2 to be described later), and second user 99 whose position is perceived by first user 98 through the presentation of the stimulus.

In the present embodiment, communication system 100 presents a stimulus to first user 98 based on information about second user 99, thereby causing first user 98 to organically perceive the position of second user 99. Stated differently, in the present embodiment, the position of second user 99 is communicated from second user 99 to first user 98 through the presentation of the stimulus. Here, communication system 100 will be described mainly with an example using an auditory stimulus as the stimulus to be presented, but the stimulus to be presented is not limited to an auditory stimulus, and may be a stimulus to any sense as long as it can stimulate at least one of the five senses of first user 98, such as a visual stimulus, a tactile stimulus, or an olfactory stimulus. In the present embodiment, the stimulus is presented as a stimulus arriving from the position of second user 99 as viewed from first user 98 toward the position of first user 98. Stated differently, a direction is imparted to the presentation of the stimulus itself. Therefore, the stimulus to be presented for communication needs to be a stimulus that can be presented with a direction. For example, in the case of an auditory stimulus, an acoustic technology known as spatial audio or three-dimensional audio may be used. Alternatively, simply, if the stimulus presenter 104 corresponding to the direction of the position of second user 99 as viewed from first user 98 from among a plurality of stimulus presenters 104 is used, the same effects can be obtained without special spatial stimulus technology.

Similarly, for visual stimuli, tactile stimuli, and olfactory stimuli, if special spatial stimuli can be performed due to technological advances or the emergence of derivative new technologies, such technologies may be used to present the stimuli with a direction, or one or more stimulus presenters 104 corresponding to the direction of the position of second user 99 as viewed from first user 98 from among two or more stimulus presenters 104 may be used to present the stimuli with a direction.

As illustrated in FIG. 1, here, first user 98 is a child, and second user 99 is a parent of the child. The child is at home, and the parent has finished work outside the home and is on the way home. In such a situation, the stimulus handled by communication system 100 is a stimulus generated at the position of second user 99, i.e., the parent. Such stimuli include, for example, in the case of auditory stimuli, walking sounds of second user 99, traveling sounds of trains and the like, and environmental sounds that occur around the position of second user 99 and that second user 99 hears. Stated differently, the term “position” in the phrase “stimulus generated at the position of second user 99” corresponds to an area having a certain range that includes even the sources of generation of environmental stimuli (environmental sounds) that second user 99 perceives (hears).

By causing first user 98 to also perceive stimuli generated by second user 99 himself or herself or at sources around second user 99, first user 98 can sense the presence of second user 99. Stated differently, second user 99 can communicate a sense of presence to first user 98. From that sense of presence, first user 98 can infer the current situation of second user 99, thereby establishing a new form of communication mediated through the conveyance of the sense of presence.

Note that applications of communication system 100 are not limited to the example illustrated in the drawing in which first user 98 at home can sense the presence of second user 99 away from home; for example, applications are also envisioned in which first user 98 in a certain room at home can sense the presence of second user 99 in a common area outside that room or in another room. As one example, communication system 100 may be configured such that a mother (first user 98) in the kitchen can sense the presence of a child (second user 99) in a child’s room, a child (second user 99) descending the stairs, a father (second user 99) in the living room, etc.

### Structure

Hereinafter, a configuration of communication system 100 according to the present embodiment will be described with reference to FIG. 2. As illustrated in FIG. 2, communication system 100 includes communication device 101, information terminal 102, detector 103, stimulus presenter 104, and storage 105.

Communication device 101 is a device that performs communication processing by controlling stimulus presentation using stimulus presenter 104 and is, for example, an information processing server realized by an edge server or a cloud server. Communication device 101 uses a processor and memory, and exhibits the functions of each functional element described below by executing a predetermined program stored in the memory. Communication device 101 includes four functional units: obtainer 111, direction determiner 121, stimulus determiner 131, and outputter 141. Obtainer 111 is a functional element that has three functions: a first obtainer, a second obtainer, and a third obtainer.

The first obtainer is a function for obtaining first position information indicating the position of first user 98. By communicating via a communication module with information terminal 102 of first user 98 or detector 103 capable of sensing first user 98, the first obtainer obtains first position information indicating the position of first user 98 from information terminal 102 and detector 103. The position granularity of first user 98 may be set as appropriate. For example, in the present embodiment in which second user 99 is away from home, the position granularity of first user 98 may be whether first user 98 is at home or not. Alternatively, when both first user 98 and second user 99 are at home and their relative position within the home is used to determine the direction of arrival of a stimulus, the position granularity of first user 98 must indicate the location of first user 98 within the home.

The second obtainer is a function for obtaining second position information indicating the position of second user 99. By communicating via a communication module with information terminal 102 of second user 99 and detector 103 capable of sensing second user 99, the second obtainer obtains second position information indicating the position of second user 99 from information terminal 102 and detector 103.

The third obtainer is a function for obtaining second user information regarding second user 99. By communicating via a communication module with information terminal 102 of second user 99 and detector 103 capable of sensing second user 99, the third obtainer obtains second user information from information terminal 102 and detector 103.

Information terminal 102 is an information processing terminal, such as a smartphone, tablet terminal, or personal computer (PC). Information terminals 102 are used by first user 98 and second user 99, respectively. Information terminal 102 includes sensors such as a global positioning system (GPS) for measuring position information and sensors capable of sensing the owner’s state and the like, and is also used for obtaining second user information (described later) by sensing.

Detector 103 is a sensor installed at home for sensing first user 98 and second user 99, or a wearable sensor worn by first user 98 and second user 99.

Direction determiner 121 is a functional element that determines a relative direction of the position indicated in the second position information with respect to the position indicated in first position information. Direction determiner 121 obtains first position information and second position information from obtainer 111. The relative position of second user 99 with respect to first user 98 is calculated by calculating the position of second user 99 indicated in the second position information with respect to the position of first user 98 indicated in the first position information. The relative position calculated here includes information of relative direction and relative distance, but may include only information of relative direction.

Stimulus determiner 131 is a functional element that determines a stimulus to be presented for communication based on obtained second user information. Stimulus determiner 131 obtains second user information from obtainer 111. A stimulus corresponding to the obtained second user information is determined by referencing storage 105. Determination of the stimulus based on second user information will be described later.

Storage 105 is a storage device that stores a plurality of stimulus candidates (here, auditory stimulus candidates) in association with information indicated in second user information. Information stored in storage 105 will also be described later together with the explanation of the determination of the stimulus based on second user information.

Outputter 141 outputs control information and transmits the control information to stimulus presenter 104 such that the stimulus determined by stimulus determiner 131 is presented as a stimulus arriving from the relative direction determined by direction determiner 121. Stated differently, outputter 141 controls stimulus presenter 104 by the control information and performs communication. Outputter 141 may output control information such that the stimulus is presented as a stimulus arriving from a distance corresponding to (for example, proportional to) the relative distance determined by direction determiner 121.

When stimulus presenter 104 presents an auditory stimulus as a stimulus as in the present embodiment, a loudspeaker may be used. Examples of such loudspeakers include televisions, stereos, headphones, smart speakers, lighting devices with integrated speakers, smartphones, tablets, and other audio output devices. However, since the loudspeaker used as stimulus presenter 104 needs to impart directionality to the presentation of the stimulus, at least two or more loudspeakers may be used. For example, as illustrated in FIG. 1, in order to present the stimulus such that the auditory stimulus arrives from the relative direction of the relative position of second user 99 with respect to the position of first user 98, the auditory stimulus is presented by stimulus presenter 104 corresponding to the relative direction among the four stimulus presenters 104 (in the case of spatial audio, by some of stimulus presenters 104 corresponding to the relative direction), and the relative direction of second user 99 is communicated.

As already mentioned, the stimulus presented by stimulus presenter 104 may be any one of a visual stimulus, a tactile stimulus, or an olfactory stimulus, in addition to an auditory stimulus. Therefore, a device appropriate for the type of stimulus to be presented may be used as stimulus presenter 104.

### Determination of Second User Information and Stimulus

Hereinafter, second user information obtained by the third obtainer described above and determination of a stimulus to be presented based on the second user information will be described.

Second user information is information regarding second user 99, as described above, and includes at least one of event information, activity information, attribute information, or vital information of second user 99.

Event information is information regarding an event scheduled for second user 99, and is obtained based on a schedule registered in advance from a schedule management server or the like (not illustrated). Event information is, specifically, for example, information regarding a state of second user 99 according to a date and time, such as during work or on the way home. Event information may also include information regarding private events of second user 99. In such cases, event information may include information regarding the state of second user 99 related to a purpose of their outing, such as walking, shopping, or camping.

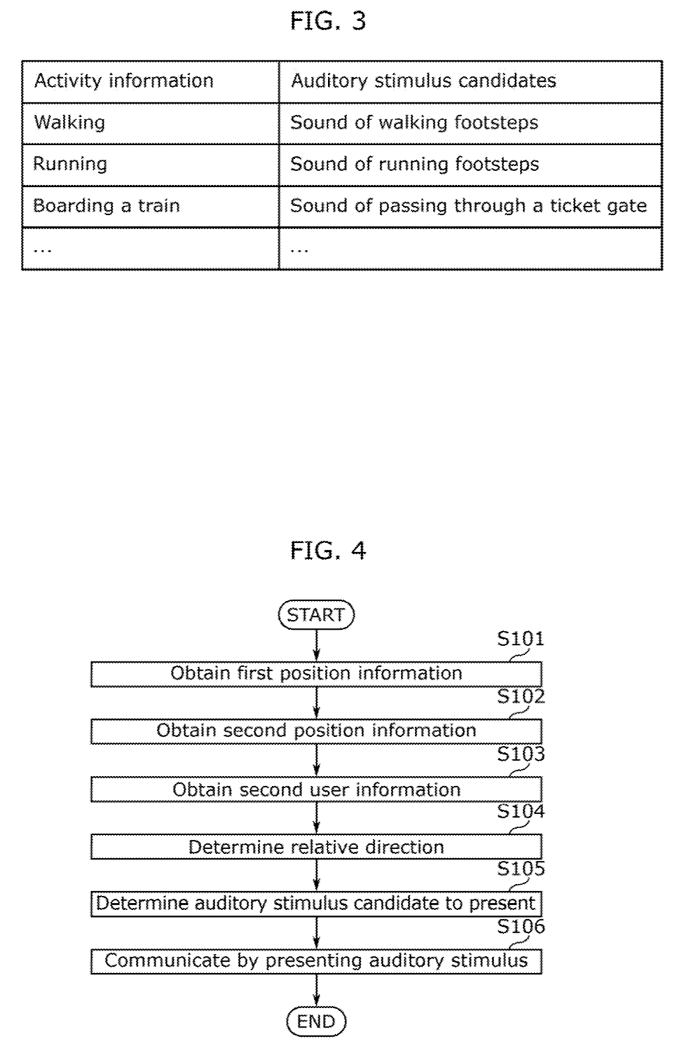

When event information is included as second user information, stimulus determiner 131 references storage 105 to select an auditory stimulus corresponding to the event information from among a plurality of auditory stimulus candidates. Event information may be used by subdividing an event indicated in the event information into several actions, that is, event information and activity information may be used in association with each other. Activity information is information indicating an action of second user 99. FIG. 3 is a diagram illustrating an example of information stored in storage according to the embodiment. As illustrated in FIG. 3, event information indicating returning home includes activity information regarding what actions are performed while returning home. Therefore, when activity information is obtained as second user information together with event information, for example, when the activity is returning home and walking, the sound of walking footsteps is determined as the auditory stimulus to be presented from among the auditory stimulus candidates (sound of walking footsteps, sound of running footsteps, sound of passing through a ticket gate) illustrated in FIG. 3. Activity information may be obtained by estimating a means of transportation based on a walking speed or the like of second user 99.

Activity information may also include information regarding actions of second user 99 performed during the event. Activity information in such cases indicates, for example, information regarding detours while returning home. Information regarding detours includes information regarding where the detour destinations are, such as a park, a sports gym, a supermarket, a bookstore, and the like. Auditory stimulus candidates include environmental sounds corresponding to such detour destination candidates, and an environmental sound corresponding to the detour destination is determined as the auditory stimulus to be presented according to where the detour destination indicated in the activity information is. As an example, when the detour destination indicated in the activity information is “supermarket”, an environmental sound corresponding to the detour destination “supermarket” (for example, a sound including the bustle of shopping and electronic sounds of cash registers) is presented to first user 98 from among the auditory stimulus candidates.

Event information may include information regarding the state of second user 99 related to a purpose of their outing as described above. In such cases, an auditory stimulus corresponding to the outing destination may be determined for presentation. For example, if the surroundings of the outing destination are a forest or the weather is rainy, the rustling of trees or the sound of rain may be determined as the auditory stimulus to be presented from among the auditory stimulus candidates. Furthermore, when the purpose of the outing is walking a pet or the like, pet sounds, walking sounds, and the like may be determined as the auditory stimulus to be presented from among the auditory stimulus candidates based on a distance between the position indicated in position information of the pet (such as a tag attached to a collar) and the position indicated in the second position information. In this manner, event information may be used for determining an auditory stimulus independently of activity information. Conversely, activity information may also be used for determining an auditory stimulus independently of event information.

Note that the auditory stimulus candidates illustrated in FIG. 3 include information on types of sounds and abstracted sounds associated therewith (such as general walking footsteps). Therefore, there is no need to prepare audio for auditory stimuli based on accurate sound collection for each second user 99; audio common to many second users 99 can be used.

However, depending on the attributes of second user 99, not using audio common to many second users 99 may enhance the immersive perception felt by first user 98. Therefore, attribute information may be used to select or correct an auditory stimulus. Attribute information is obtained based on personal information stored in a smartphone or the like of second user 99, and includes parameters that can affect auditory stimuli emitted by second user 99 himself or herself, such as, for example, gender, age, and weight. For example, when second user 99 has a heavy body weight (i.e., the weight indicated in the attribute information is greater than or equal to a threshold), correcting footsteps to have deeper bass tones enhances the immersive perception of the presence of second user 99 felt by first user 98. Similarly, when second user 99 is an adult (i.e., the age indicated in the attribute information is greater than or equal to a threshold), correcting footsteps to have deeper bass tones enhances the immersive perception of the presence of second user 99 felt by first user 98. Alternatively, different auditory stimuli may be selected by referencing different databases depending on the attribute information.

Vital information is used to determine an auditory stimulus by being used to estimate activity information or by being used alone. Vital information is obtained by sensing second user 99. Vital information is, for example, information indicating the pulse of second user 99, and is used to estimate the exercise intensity of second user 99, that is, to estimate activity information regarding what exercise intensity activity second user 99 is performing. For example, vital information is information indicating the body temperature of second user 99, and when the body temperature is greater than or equal to a threshold, vital information may be used to determine an alert sound indicating poor physical condition of second user 99 as the auditory stimulus to be presented from among the auditory stimulus candidates.

After obtaining the second user information in the manner described above, stimulus determiner 131 determines the auditory stimulus to be presented from among the auditory stimulus candidates.

### Operations

Next, operations of communication system 100 described above, particularly operations of communication device 101, will be described with reference to FIG. 4. FIG. 4 is a flowchart illustrating an operation example of the communication device according to the embodiment.

When operations of communication system 100 are started, first, obtainer 111 obtains first position information by communicating with information terminal 102 or detector 103 via a communication module (first obtaining step S101). Obtainer 111 also obtains second position information by communicating with information terminal 102 or detector 103 via a communication module (second obtaining step S102). Obtainer 111 further obtains second user information by communicating with information terminal 102 or detector 103 via a communication module (third obtaining step S103). First obtaining step S101, second obtaining step S102, and third obtaining step S103 need not be performed in this order, and may be performed in an order different from that in FIG. 4 or may be performed in parallel.

Direction determiner 121 uses the obtained first position information and second position information to determine a relative position of the position indicated in the second position information with respect to the position indicated in the first position information (determining step S104). The determined relative position includes relative direction and relative distance, and thus determining step S104 can also be said to be a step of determining relative direction.

Next, stimulus determiner 131 determines an auditory stimulus to be presented from among a plurality of auditory stimulus candidates based on the obtained second user information (stimulus determining step S105).

Outputter 141 generates control information and outputs the control information to stimulus presenter 104, thereby controlling stimulus presenter 104 to communicate by presenting the auditory stimulus determined by stimulus determiner 131 as an auditory stimulus arriving from the relative direction determined by direction determiner 121 (output step S106). Output step S106 is executed, for example, in conjunction with a schedule related to event information (that is, such that the auditory stimulus to be presented switches in accordance with switching between events). With this, the auditory stimulus to be presented switches in synchronization with the schedule, thereby improving the real-time nature of the presented stimulus.

In the manner described above, in the presentation of a stimulus for communication, the concept of direction, namely the direction of arrival of the stimulus, is imparted to the stimulus itself, and the position, that is, the relative position of second user 99 with respect to first user 98, can be passively perceived from the presented stimulus. Furthermore, an organic presentation can be performed that allows first user 98 to perceptually recognize the position. Furthermore, since first user 98 merely needs to passively perceive the presented stimulus to receive communication of information about the relative position of second user 99, first user 98 can continue their current task without interruption while simultaneously being made aware of the relative position of second user 99. This enables more appropriate communication based on information about second user 99.

### Other Embodiments

While one or more exemplary embodiments have been described above, the present disclosure is not limited to the above-described one or more embodiments.

For example, the communication system described in the above embodiments may be implemented as a single device including all elements, or may be implemented by a plurality of devices, with each function allocated to the devices and these devices cooperating with each other. In the latter case, an information processing device such as a smartphone, tablet terminal, or personal computer (PC) may be used as a device corresponding to the communication device.

In the above one or more embodiments, processing executed by a specific processor may be executed by another processor. Moreover, the order of the plurality of processes may be changed, or the plurality of processes may be executed in parallel.

Moreover, in the above one or more embodiments, each element may be realized by executing a software program suitable for the element. Each of the elements may be realized by means of a program executing unit, such as a central processing unit (CPU) or a processor, reading and executing the software program recorded on a recording medium such as a hard disk or a semiconductor memory.

Each element may be implemented by hardware. For example, each element may be a circuit (or an integrated circuit). These circuits may constitute one circuit as a whole, or may be separate circuits. These circuits may each be a general-purpose circuit or a dedicated circuit.

General or specific aspects of the present disclosure may be realized as a device, an apparatus, a method, an integrated circuit, a computer program, or a computer-readable recording medium such as a CD-ROM. General or specific aspects of the present disclosure may be realized as any given combination of a device, an apparatus, a method, an integrated circuit, a computer program, and a recording medium.

For example, the present disclosure may be implemented as a communication method executed by a computer, or may be implemented as a program for causing a computer to execute a communication method. The present disclosure may be implemented as a computer-readable non-transitory recording medium having the program recorded thereon.

Embodiments arrived at by a person skilled in the art making various modifications to any one of the embodiments, or embodiments realized by arbitrarily combining elements and functions in the embodiments which do not depart from the essence of the present disclosure are also included in the present disclosure.

### INDUSTRIAL APPLICABILITY

The present disclosure is applicable in communication based on information about a second user.

1. A communication method comprising:
obtaining first position information indicating a position of a first user who is a target recipient of communication;
obtaining second position information indicating a position of a second user different from the first user;
determining a relative direction of the position indicated in the second position information with respect to the position indicated in the first position information; and
communicating using a stimulus presenter capable of presenting a stimulus to the first user, the communicating including presenting a stimulus arriving toward the position indicated in the first position information from the relative direction determined, wherein
the stimulus presented in the communicating corresponds to a stimulus generated at the position of the second user.

2. The communication method according to claim 1, wherein
the stimulus presented in the communicating is at least one of a visual stimulus, an auditory stimulus, a tactile stimulus, or an olfactory stimulus.

3. The communication method according to claim 1, further comprising:
obtaining second user information regarding the second user; and
determining the stimulus to be presented in the communicating based on the second user information obtained.

4. The communication method according to claim 3, wherein
the stimulus to be presented in the communicating is an auditory stimulus, and
in the determining of the stimulus, the auditory stimulus to be presented as the stimulus in the communicating is determined from among a plurality of auditory stimulus candidates based on the second user information.

5. The communication method according to claim 3, wherein
the second user information includes at least one of event information, activity information, attribute information, or vital information of the second user.

6. The communication method according to claim 5, wherein
the event information is obtained based on a schedule registered in advance for the second user.

7. The communication method according to claim 6, wherein
the communicating is executed in conjunction with the schedule related to the event information.

8. The communication method according to claim 5, wherein
the activity information is obtained by sensing the second user, or is obtained based on the event information.

9. The communication method according to claim 5, wherein
the attribute information is obtained based on personal information of the second user.

10. The communication method according to claim 5, wherein
the vital information is obtained by sensing the second user.

11. A communication device comprising:
a first obtainer that obtains first position information indicating a position of a first user who is a target recipient of communication;
a second obtainer that obtains second position information indicating a position of a second user different from the first user;
a direction determiner that determines a relative direction of the position indicated in the second position information with respect to the position indicated in the first position information; and
an outputter that uses a stimulus presenter capable of presenting a stimulus to the first user to present a stimulus arriving toward the position indicated in the first position information from the relative direction determined, wherein
the stimulus presented by the outputter corresponds to a stimulus generated by the second user.

12. A non-transitory computer-readable recording medium for use in a computer, the recording medium having a computer program recorded thereon for causing the computer to execute the communication method according to claim 1.
